(19) United States
(12) Patent Application Publication
(10) Pub. No.: US 2010/0020784 A1
(43) Pub. Date: Jan. 28, 2010

(54) APPARATUS, NETWORK AND METHOD FOR IMPLEMENTING TDM CHANNELS OVER A CSMA SHARED MEDIA NETWORK

(75) Inventors: Shmuel Goldfisher, Petach-Tikva (IL); Erez Geva, Gan-Yavne (IL); Merav Ben-Elia, Tel-Aviv (IL)

Correspondence Address: MARTIN D. MOYNIHAN d/b/a PRTSI, INC., P.O. BOX 16446, ARLINGTON, VA, 22215, US

(73) Assignee: Main.Net Communications Ltd., RaAnana (IL)

(21) Appl. No.: 12/523,996

(22) PCT Filed: Jan. 29, 2008
(86) PCT No.: PCT/IL2008/000130

§ 371 Date: Jul. 22, 2009

Related U.S. Application Data
(60) Provisional application No. 60/886,992, filed on Jan. 29, 2007.

(51) Int. Cl. H04B 7/212

(52) U.S. Cl. 370/347

(57) ABSTRACT

A carrier sense multiple access network comprises communication nodes which communicate with other nodes over the network using carrier sense multiple access (CSMA). The nodes further comprise channel support capability to set up multiplex channel connections between specific nodes over the CSMA based network. The network thus may reduce conflict issues raised by CSMA and at the same time improve bandwidth utilization.

### FIELD AND BACKGROUND OF THE INVENTION

The present invention, in some embodiments thereof, relates to implementation of Time Division Multiplex (TDM) channels over a carrier sense multiple access (CSMA) shared media network, and more particularly but not exclusively to a power line network.

A Carrier Sense Multiple Access (CSMA) shared media network is a network protocol in which all the network communication units have the same rights to transmit (sometimes with limited prioritization), and where there is no central management in terms of governing which unit can transmit at any given time.

Carrier Sense Multiple Access or CSMA is a probabilistic Media Access Control (MAC) protocol in which a node verifies the absence of other traffic before transmitting on a shared physical medium, such as an electrical bus, or a band of the electromagnetic spectrum.

The term “Carrier Sense” is used to describe the fact that a transmitter listens for a carrier wave before trying to send. That is, it tries to detect the presence of an encoded signal from another station before attempting to transmit. If a carrier is sensed, the node waits for any transmission in progress to finish before initiating its own transmission.

The term “Multiple Access” describes the fact that multiple nodes send and receive on the medium. Transmissions by one node may be received by multiple nodes using the medium.

Thus, in a CSMA network any two given units, for example, may transmit data at the same time. If these two units, for example, transmit concurrently, and are sufficiently close and/or the transmission power is sufficiently high, this may lead to frame collisions. The multiple transmissions may interfere with each other so that all are garbled and receivers are unable to distinguish the overlapping received signals from each other. It is impossible to entirely prevent collisions in CSMA networks, but there are several modifications to pure CSMA which attempt to do this.

In pure CSMA, only the carrier sense is used to avoid collisions. If two nodes try to send a frame at nearly the same time, neither detects a carrier so both begin transmitting. The transmitters do not detect collisions, so transmit the entire frame (thus wasting the bandwidth used). A common assumption, often true in practice, is that receivers cannot distinguish between collisions and other sources of frame errors, so collision recovery relies on the ability of the communicating nodes to detect frame errors and invoke an error recovery procedure. For example, the receiver may not send a required ACK, causing transmitters to time out and retry.

In Carrier Sense Multiple Access with Collision Avoidance (CSMA/CA), each node listens to the medium or line to see if it is free for transmission. If the medium is actually free, the node begins the transmission with the first data frame. Collision avoidance is used to improve CSMA performance by terminating transmission as soon as a collision is detected, and reducing the probability of a second collision on retry. However, in many network arrangements it is not possible to listen to the network and transmit simultaneously.

In Carrier Sense Multiple Access with Collision Detection (CSMA/CD), sending nodes are able to detect when the connection is being used and stop transmitting immediately, backing off for a random amount of time before trying again. The idea is that each node waits for a different amount of time, and one will start first, and the other will notice and not transmit. This results in much more efficient use of the media since the bandwidth for transmitting the entire frame is not wasted. However, it is not possible with all media (e.g., radio), and requires extra electronics.

In Carrier Sense Multiple Access with Bitwise Arbitration (CSMA/BA, also known as CSMA/CR—collision resolution), all of the nodes on the bus are assigned an identification number or priority code. When a collision occurs, one of the nodes that are attempting to send at the same time will be given priority to transmit according to its identification number or priority code.

There is another newer technology called Carrier Sense Multiple Access with Collision Prevention (CSMA/CP).

With CSMA/CA collision avoidance is used to improve the performance of CSMA by attempting to be less “greedy” on the medium. If the medium is sensed busy before transmission then the transmission is deferred for a random interval. This reduces the probability of collisions on the medium.

CSMA/CA is used, for example, in 802.11 based wireless LANs. One of the problems of wireless LANs is that it is not possible to listen while sending, therefore actual detection of a collision in progress is not possible, and therefore CSMA/CD cannot be used.

Carrier Sense Multiple Access with Bitwise Arbitration (CSMA/BA, also known as CSMA/CR—collision resolution), is sometimes used in CAN communications, often found on vehicles.

CSMA-based protocols, when used in multi-hop networks, generally use CSMA/CA or token based protocols. However, since these networks are characterized in that the topology of the network prevents or makes it less feasible to have a direct connection among units, such implementations may often lead to non-trivial packet losses, high jitter, and reliability issues associated with using a shared medium. It would be advantageous to have a system or method to enable effective establishment and implementation of CSMA networking in a multi-hop network that makes efficient use of the bandwidth and helps provide a guaranteed quality of service.

### SUMMARY OF THE INVENTION

According to an aspect of embodiments of the invention there is provided a networking arrangement for multiple hop networks in which time division multiplex channels are superimposed on the CSMA network infrastructure.

According to an aspect of some embodiments of the present invention there is provided a network communication unit supporting carrier sense multiple access (CSMA) to a plurality of transmitter and receiver units on a network, the apparatus comprising:

a CSMA management module configured to support communication using CSMA with surrounding units; and

a channel management module associated with the CSMA management module and enabled to establish a multiplexed channel with at least one other communication unit over a CSMA based network.

In an embodiment, the CSMA based-network is a power line network.

In an embodiment, the multiplex channel is a time division multiplex channel.

In an embodiment, the channel management unit is configured to manage separate transmit and receive channels.

In an embodiment, the channel management unit is configured to manage separate channels when the network communications unit communicates with the other units.

In an embodiment, the channel management unit is configured to manage separate transmit and receive channels when the network communications unit communicates with the other units.

In an embodiment, the channels are time multiplexed channels having time slots, one of the channels is a predecessor in a multi-channel link, and another of the channels is a successor channel thereto, the channel management unit being configured to allocate the successor channel a time slot that immediately follows a time slot of the predecessor channel, thereby to minimize channel latency.

According to a second aspect of the present invention there is provided a carrier sense multiple access (CSMA) network comprising communication units configured to communicate with other units over the network using CSMA, at least some of the units further comprising channel support capability to set up channel connections for communicating between each other using a multiplex channel.

In an embodiment, the channel support capability is located in a head end unit, such that the head end unit is configured to select units, to set up the channel connections between the selected units.

In an embodiment, the channel support capability comprises time division multiplexing to support time division multiplex channels.

In an embodiment, the channel support capability comprises time slot allocation to allow multiple channels to coexist on a given link of the network.

In an embodiment, the channel support capability comprises variable time slot allocation to vary bandwidth according to channel requirements.

In an embodiment, the variable time slot allocation is configurable to vary a width of a timeslot over a lifetime of a channel.

In an embodiment, the channel support capability is configured to set up successive channels along a communication path and to coordinate time slots along the successive channels, thereby to minimize latency.

In an embodiment, the channel support capability is configured to set up channels in multiple directions along a communication path.

In an embodiment, the channel support capability is configured to set up two communication paths for bi-directional communications between two given units, each path for one direction of the bi-directional communication.

An embodiment may be configured to use channel sense multiple access to alert the channel support capability to set up a multiplex channel, and further configured to use time division multiplex signaling to set up the channels between units.

In an embodiment, the units are further configured to set time slots of paired up and down channels such that time slots in one of the channels are phased, and time slots originating at given units in the other of the channels are allocated to immediately follow a phased time slot arriving at a respective node.

In an embodiment, the channel management is configured to use channel sense multiple access nearcast to communicate with neighboring units regarding the multiplex channels.

The network may be configured such that neighboring units are informed of a multiplex channel in the vicinity using the nearcast, thereby to set up time slots of the multiplex channel as guard slots during which the respective neighboring units do not issue communications.

In an embodiment, the multiplex channel comprises a time division multiplex (TDM) channel.

According to a third aspect of the present invention there is provided a method of communicating over a carrier sense multiple access (CSMA) network, comprising:

using CSMA messaging to request a path over the CSMA network;

setting up multiplex channels along the path; and

communicating using the multiplex channels.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1A is a simplified diagram showing a communication unit according to a first embodiment of the present invention;

FIG. 1B is a simplified diagram showing the communication unit of FIG. 1 located within a CSMA network;

FIG. 2 is a simplified diagram of a CSMA network modified with a head end unit to support TDM channels according to an embodiment of the present invention.

FIG. 3 is a schematic diagram illustrating the establishing of a TDM channel using a cone channel, according to some embodiments;

FIG. 4 is a schematic diagram illustrating the establishing of a TDM channel using an equal side channel, according to some embodiments;

FIG. 5 is a schematic diagram illustrating an additional example of establishing of a TDM channel using an equal side channel, according to some embodiments;

FIG. 6 is a schematic diagram illustrating the establishing of a TDM channel by using an unequal path, according to some embodiments;

FIG. 7 is a schematic diagram illustrating a channel aggregation process on an equal side channel, according to some embodiments; and

FIG. 8 is a schematic diagram illustrating the establishing of a TDM channel by using a “change on the fly” signaling method, according to some embodiments.

### DESCRIPTION OF EMBODIMENTS OF THE INVENTION

The present invention, in some embodiments thereof, relates to implementation of Time Division Multiplex (TDM) channels over a carrier sense multiple access (CSMA) shared media network, and more particularly but not exclusively to such an implementation over a power line network.

Carrier sense multiple access is a way of sending frames of data over multiple hops to a destination, and is a protocol designed for the type of network architecture in which multiple units are connected haphazardly to communication links. As pointed out in the background however different units can transmit on the same links and thus collisions cannot fully be prevented. Time division multiplex channels expect a more orderly infrastructure in which transmitting and receiving nodes are clearly defined. The present embodiments layer time division multiplex over carrier sense multiple access so that the carrier sense multiple access can provide an infrastructure to allow the time division multiplex channels to be set up between a sender and a clearly defined receiver channel. Time division multiplexing then allows time slots to be set up to share bandwidth between different channels using the same connection.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

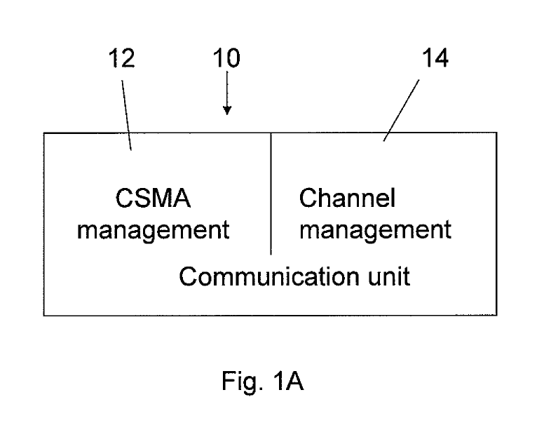

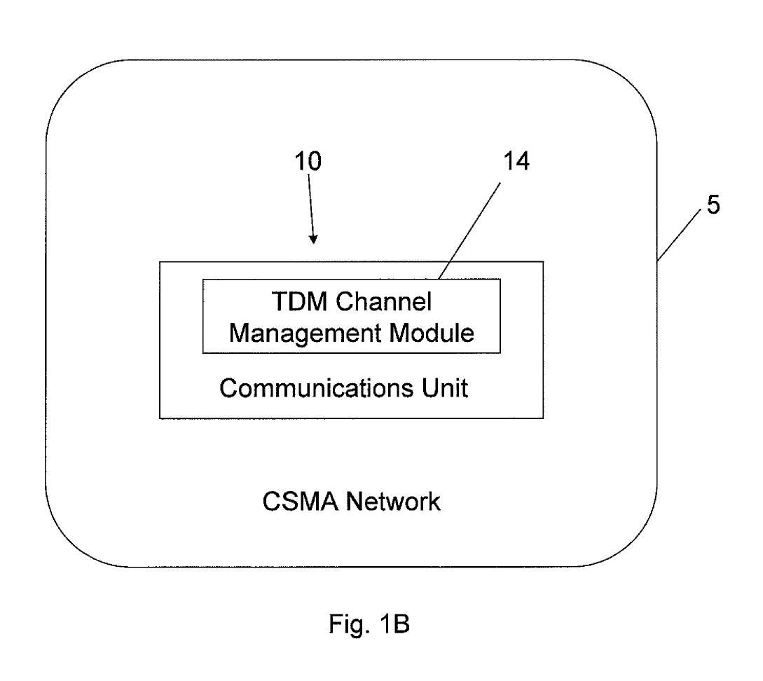

Referring now to the drawings, FIG. 1A is a simplified diagram that illustrates a network communication unit 10 such as a modem, repeater, edge unit, or head end unit, for example, of the kind used to support communication across a network such as a power line network. Communications Unit 10 may enable communications to be sent from one communications unit to the next until they arrive at the intended destination. The unit 10 is able both to receive data and send the data along the network. The unit 10 includes the ability to send or receive data using the carrier sense multiple access protocol so that when using this protocol it only sends data when it has sensed that the line is clear. The data sent is received by any other unit or node on the line, irrespective of whether it is the intended recipient. The unit or node 10 may receive any data sent on the line, whether or not it is the intended recipient, unless it is itself the sender.

Communications Unit 10 includes a carrier sense multiple access (CSMA) management module or block 12 for carrier sense operations, that is to say for sensing connections with other communication units on network, and thus to make sure that a condition for transmitting to other units is that the network connection is currently free. In addition the unit includes a channel management module or block 14 which enables unit 10 to establish channels such as TDM channels between selected units in a network, where the network is for example, a power line communications (PLC) network. Channel management block 14 enables setting up a path across a network from an origin to a destination via a series of such connections to create a TDM channel path or a multi-hop channel in a CSMA based network.

Reference is now made to FIG. 1B which shows an example of the unit 10 including the channel management module located in CSMA network 5. The channel management module is herein shown as a time division multiplex (TDM) management module so that the path set up comprises TDM channels.

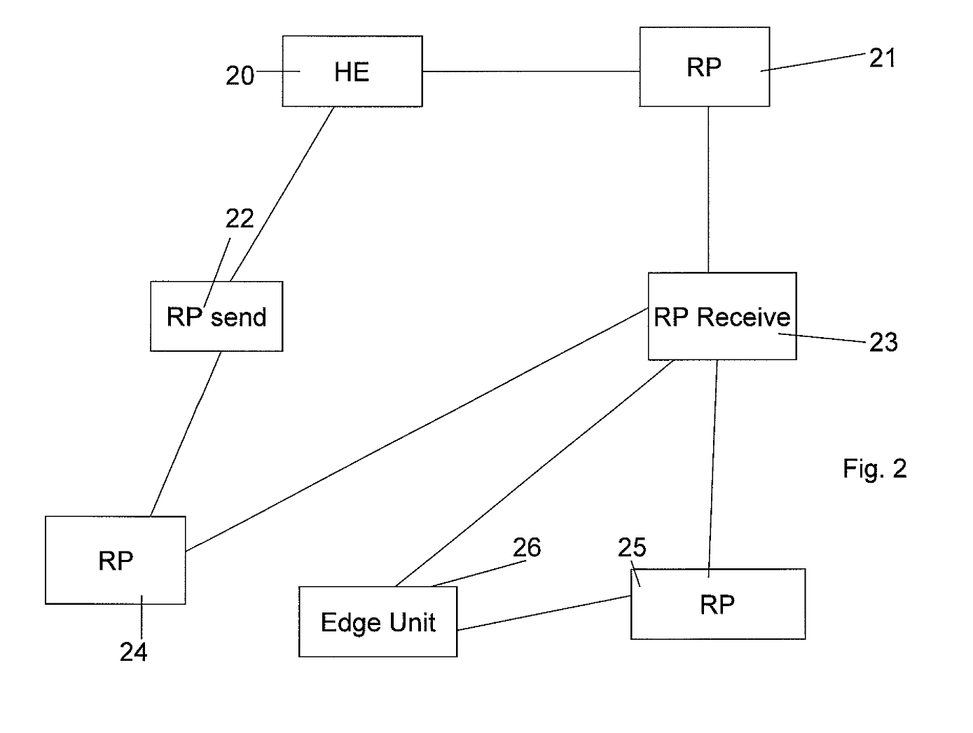

Reference is now made to FIG. 2, which is a simplified schematic diagram of a network such as a power line network. The power line network includes nodes of three kinds, a head end unit or HE 20, an edge unit 22 where the network meets another kind of network such as a domestic network, and repeaters (RP) 24.

In use, when Edge Unit 26 wants to open a TDM channel to HE 20, Edge Unit 26 may send a request to HE 20 (e.g., using the CSMA protocol) to establish such a channel. If HE 20 agrees to establish the channel, HE 20 may communicate with RP 21, directing RP 21 to allocate a time slot between HP 20 and RP 21, to deliver data between HE 20 and Edge Unit 26. RP 21 will likewise communicate with RP Receive 23, directing RP Receive 23 to allocate a time slot between RP 21 and RP Receive 23, to deliver data between HE 20 and Edge Unit 26. This pattern may be repeated until the channel creation commands arrives at Edge Unit 26, at which time a TDM channel has been established at selected time slots between HE 20 and Edge Unit 26.

Thus, when edge unit 26, wants to set up a channel, for example because it has a frame of data to send to a specific other unit, say Head End unit 20, the sending unit sends a message to head end unit 20 to request that the channel be set up. The head end unit 20 then initiates channel setup between HE 20 and RP Send 22, and between HE 20 and RP Receive 23. The channel formed between RP Send 22 and RP Receive 23 may include one or more sub-channels.

As mentioned above, what is set up is not merely a single hop-channel between first and second units but rather a connection path for a communication between a source and a destination over the network, the path including multiple hops over different repeaters.

In an embodiment, the multiplex channel that is set up is a time division multiplex channel. Using time division multiplexing, two or more channels can coexist on the same link. Each channel is assigned its own time slot and no collision condition arises.

The HE 20 may simultaneously manage separate transmit and receive channels, and may also manage channels or send and receive channel pairs to more than one other unit.

In any given bidirectional channel path there is no particular reason why the channels in each direction should follow the same route, and examples are given below.

As mentioned, channels that share the same physical link have their own time slots. In one embodiment allocation of time slots is such that a particular path has its time slots phased so that a successor unit receives time slots that immediately follow time slots of a preceding channel. In this way channel latency can be minimized. Phasing of time slots can be applied discriminatingly to paths requiring a high quality of service, for example paths carrying video.

In some embodiments, slot size is fixed. In other embodiments, the size of the slots can be varied to provide different bandwidths to different channels depending on the channel requirements or quality of service. For example, different slot sizes may be used in accordance with the available bandwidth of different links (e.g., different SNR's for different links may affect the slot times or sizes).

The embodiments thus enable using of Time-Division Multiplexing (TDM) within the broader usage of CSMA/CA, so that applications requiring guaranteed quality of service (QoS) may be executed using CSMA. The usage of TDM channels may enable the controlling of latency, bandwidth, jitter and other relevant QoS factors.

For example, TDM channels may have a defined latency and may therefore allow latency management. It is thus possible to provide lower latency for applications that require highly time sensitive data transfers, for example voice over IP, broadband video etc—where real time data arrival is important.

In some embodiments the various Head End units may utilize a routing mechanism to connect any two units using the best path, which may include, for example, several units along the communications path. These Head Ends may be required to know what the next network point or node is, and how to access it, in order to efficiently allocate transmission time for each node, and thereby increase or maximize space-time usage.

The following abbreviations are used herein: CSMA—Carrier sense multiple access; CQ—Channel quality; HE—Head End unit; TDM—Time-division multiplexing; NTU—Network Terminator Unit; RP—Repeater Unit.

According to some embodiments of the present invention, any communications unit in a CSMA network may initiate a Time-division multiplexing (TDM) channel, for example, to enable transmission of data or bit streams between two or more units in a CSMA network A communications unit, for example, may send a request message to a Head End (HE), for example using a CSMA message. The message may include, for example, a request to establish a TDM channel. The request may include the final destination of the TDM channel to be established. The destination may be the HE or any other unit in the network. The Head End is a unit of the network which is denoted as being the Head End by the network operator and/or manufacturer. The HE unit may be a unique unit from the manufacturer for this purpose, or another device or unit in the network that has a mode in which it can also perform as a HE. The network may be specifically provided with a HE for each network cell. The HE unit may be utilized, for enabling the creation of a TDM channel in the network. The HE may be the focal point of the network to, for example, a WAN, thereby connecting the network to the outside world. The HE may have additional functions, for example, bandwidth limitation, unit authentication, bandwidth classification, user authentication, network management etc.

The HE may process requests from network components to set up TDM channels, and may decide or determine whether to authorize the new channel, to reuse an existing TDM channel, to deny the setting up of the new channel etc.

In some embodiments the HE may initiate a TDM channel to another unit in the network, for example, to a different unit from the requested target unit. Upon receiving a TDM channel request, the HE may decide whether or not to initiate a channel. The decision may be based on the amount of communication already on the particular physical infrastructure, the current noise levels and the like and in accordance with overall capacity limitations declared by the operator and/or manufacturer. For example, it may base such a decision on the number of calls or TDM sessions, the total bandwidth that a specific TDM channel can handle, the total bandwidth of the TDM channels in the entire network, the total bandwidth of the entire network, the specific privileges of the call initiator, and/or any other consideration(s) the operator and/or manufacturer may consider relevant. If a request to open a channel is denied, the HE may send a negative response using a CSMA message to that unit. If a request to open a channel is accepted, the HE may generate a TDM channel ID, send a positive TDM channel response and establish the TDM channel.

Upon acceptance, after sending a positive response to the other communications unit, the HE may establish the TDM channel. The TDM channel may transmit data bi-directionally between communication units in the network. In some embodiments the download and upload paths may be split. Using the path created by the routing for the TDM channel, the HE may start a chain reaction between multiple communication units to set up the channels. The communications that may be used to set up the channels are hereinafter referred to as signaling. That is to say the HE tells the units themselves to set up the channels and then they proceed automatically with the necessary set up protocols until the link is set up along the path.

The HE may create, for example, one down-link path from the HE to a destination unit, and one up-link path from the destination unit to the HE. In the down-link the HE may function as the transmitter, while on the up-link, the HE may function as the receiver. The channel may be asymmetric in the case where the signaling is split into two separate paths, one path for up-link and one path for down-link.

When initiating a multi-hop path, also referred to herein as a channel path or just as a channel, from the HE, the signaling may continue until both the up-link and the down-link have reached the unit that initiated the TDM channel path. At this point the TDM channel path is up and running until an abort signaling is initiated by either the HE or the initiating unit.

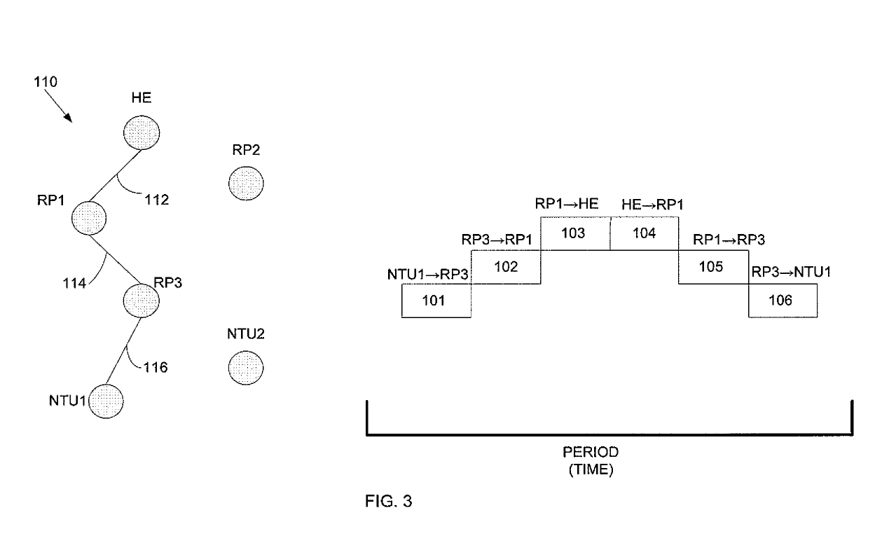

Reference is now made to FIG. 3, which is a simplified schematic diagram illustrating a channel path incorporating a cone-shaped channel, according to some embodiments. Links of the channel are shown over a time axis to give an indication of relationships of time slots over successive connections of the link. A cone shaped channel is one in which the up and down links are both phased towards a common head, as will be explained below. The method of phasing towards the head, the cone channel method, may be used to establish the TDM channel. The term “cone-shaped” is used because of the shape of the TDM channel in both directions, as they appear on a time axis as per FIG. 3. The channel may be initiated from the HE, where the down-link and the up-link are back to back, and the channel may end at the requesting unit where there is a separation with a large time gap between the down-link and up-link slots.

In FIG. 3, blocks 101-103 represent the uplink to the HE, and blocks 104-106 represent the downlink from the HE. On the down-link, the time slots may be allocated in the same order as the traffic routing. For example, the time slot for the transmission from RP3 to NTU1 (e.g. block 106) comes after the time slot for transmission from RP1 to RP3-105. In a similar fashion, the order of time slots in the uplink may also correlate to the routing path. For example, the time slot for the transmission from NTU1 to RP3 (e.g. block 101) may come before the time slot for transmission from RP3 to RP1 102.

In channel path diagram 110, the down-link may be built in the positive direction, while the up-link may be built in the reverse direction. For example, TDM channel 110 can be built from 3 hops, 112, 114 and 116. Blocks 101-106, which represent the time slots, show a cone-like appearance. Other configurations and numbers of hops may be used.

The cone channel method is a way of managing latency, and may be particularly effective for a network with many hops and a small number of units. The cone channel method may however use more time slots, for example, in a non-parallel way, and may therefore actually consume additional bandwidth in order to achieve the phasing. Further, when using the cone channel method, there may be small or negligible gaps between successive time slots.

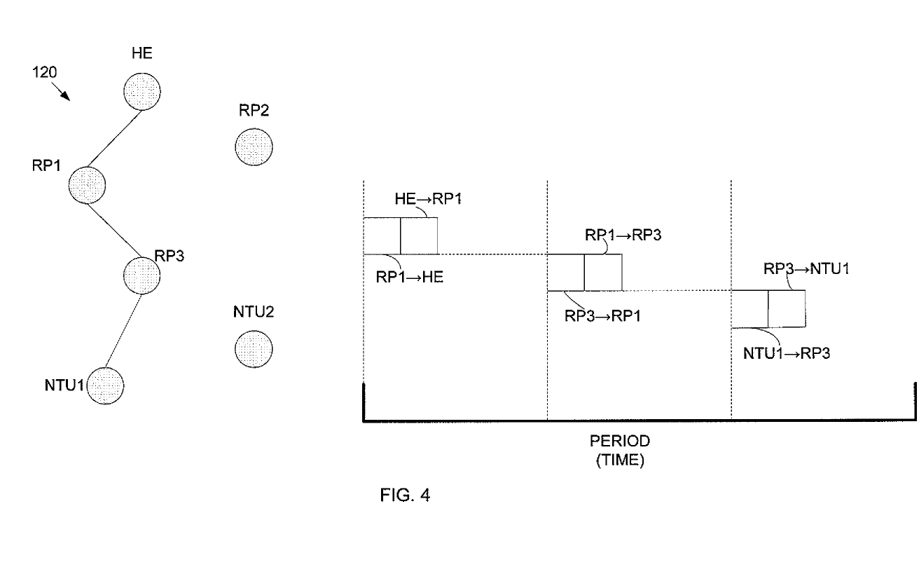

Reference is now made to FIG. 4, which is a simplified schematic diagram illustrating an alternative path establishment method, referred to herein as the equal side method, according to some embodiments. In this method, as can be seen with reference to FIG. 4, a base time period may be divided into a variety of time slices. In each time slice a variety of time slots may be allocated, as needed. The number of time slices may be allocated in accordance with the number of hops that interfere with each other on a specific TDM channel path. For example, CSMA network 120 may include 3 hops between HE and NTU1. These hops, since they are on the same path, may interfere with each other, thereby preventing data transmission between various hops during the same time slot. Therefore the time slot may be divided into 3 time slices in relation to the 3 interfering hops. The data may be subsequently transmitted along the TDM channel in time slots allocated within the time slices. For example, in some embodiments a double period may be used, which may be divided into three parts to reduce the fragmentation of the CSMA time slots. It is noted that CSMA time slots are created in the present embodiments by integrating TDM channels into the transmission conducted between nodes or units in a CSMA network. For example, the creation of a TDM channel will lead to a division of the transmission between units into time slots. The time slots used for the TDM channel are herein referred to as TDM slots, and the remaining time slots are herein defined as CSMA time slots. Each hop may, for example, use the next slot of the three in a round-robin fashion. For example, the first hop (the HE) takes the first slot and so forth, as can be seen in the Figure. Other slot periods or intervals may be used.

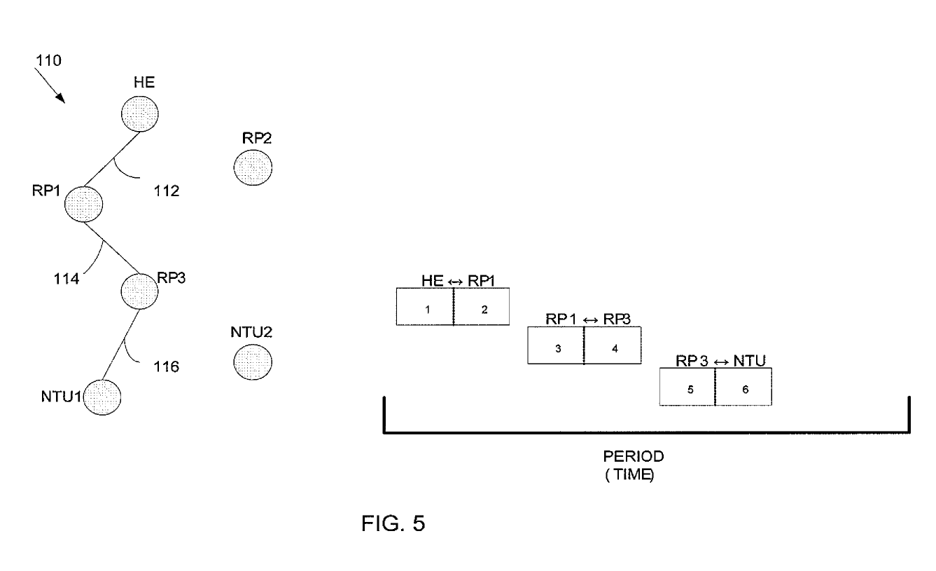

Reference is now made to FIG. 5, which is a simplified diagram illustrating an alternative equal side channel method, which may be used to establish the TDM channel, according to some embodiments. According to an example of this method, the unit that allocates a time slot for transmission may also allocate the slot for the return channel. The return channel may thus be established substantially immediately after the transmission. Thus, the HE may allocate the slot to transmit to RP1 and the slot for RP1 to transmit back in reply. In one embodiment a unit may define the slot between itself and the next hop and in addition, may define the slot between the next hop and the subsequent hop. In the above example, the HE may define the slots HE<->RP1 and RP1< >RP3. This may continue as long as the unit has visibility about the route in future hops. The method may facilitate a relatively simple and fast creation or setup, and may deliver a short latency on the downstream, although not on the upstream since it is not possible to phase if the upstream slots depend on the downstream ones and not on each other That is to say, the method may deliver a relatively high latency on the upstream. Thus, if the NTU has data to transmit back to the HE shortly after its slot has passed, it may need to wait until the next TDM period to transmit to RP3. RP3 may accordingly need to wait another TDM slot in order to transmit to RP1 and so on. The upstream latency may be calculated by multiplying (TDM Period time)*(#hops). In some implementations when the latency is substantially important on the downstream, for example for some applications of IPTV, the above method may be effectively implemented. More generally this method is useful for example in server to peer connections which require high quality of service in the server to peer direction and low quality of service in the return channel.

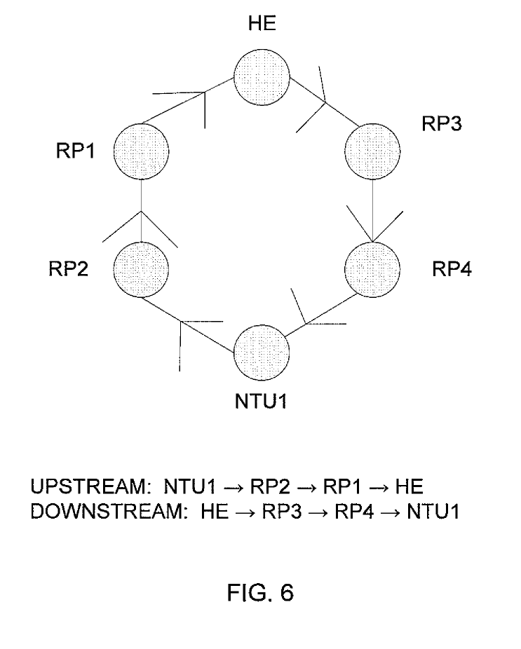

Reference is now made to FIG. 6, which is a simplified diagram illustrating the case where the up and down channels do not follow the same path. According to some embodiments, a TDM channel may use different paths for the downlink and uplink. As can be seen, the uplink may begin, for example, at NTU1 and may lead to HE, via RP2 and RP1. The downlink may begin, for example, at HE and may lead to NTU1, via RP3 and RP4. The split may be made, for example, at HE, at the destination unit, or/and at any other unit along the path.

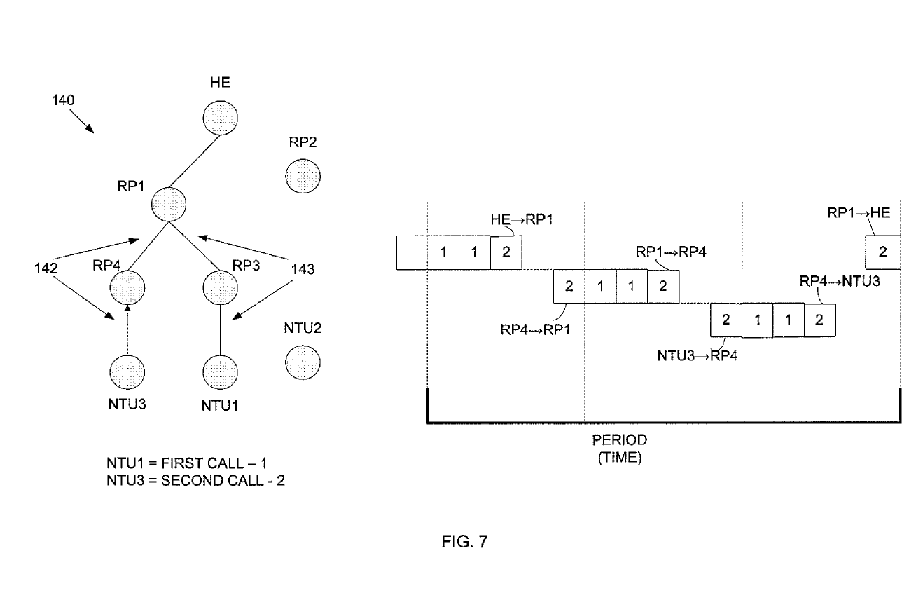

Reference is now made to FIG. 7, which is a simplified schematic diagram illustrating how the equal side channel method may enable easy aggregation of TDM channels, and may leave larger fragments for CSMA time slots, according to some embodiments. For example, network 140 may include 2 TDM channels, 142 and 143. Channel 143 let us say is the new channel, and may be assigned to new time slots that are placed within the existing time slices. In this case, the hop between HE and RP1 is a shared hop for both TDM channels 142 and 143. Time slots of both channels are allocated back to back, and this may enable the transmission of data between HE and RP1 for both channels in a combined time slot. This may help increase the efficiency of the data transfer in this hop.

The equal side channels may also occupy less of the shared bandwidth, which may be particularly effective for density networks with a limited number of hops. However, the latency may grow with the number of hops, for example, according to the formula:

Latency=number of hops*(slot length/number of time slices)

In all of the above examples the TDM channel paths have begun or ended at a head end unit. According to some embodiments, a TDM channel may be established between 2 units without starting or ending at the HE. In the case where the TDM channel is between two units of which neither one is the HE, the initial request may be sent to the HE as well. On acceptance by the HE, a positive response may be sent to both units, who then use their own resources to synchronize and set up the channels.

On the other hand, in the case where the second unit is unable to build a TDM channel, it may send a notification to both the initiating unit and to the HE, or else the second unit may simply send a positive response to the initiating unit. The second unit may then begin signaling in one direction towards the initiating unit. On receiving both positive responses from the HE and the second unit, the initiating unit may start a signaling process in the direction of the second unit. Each of the units may start a process of signaling in which they are transmitters, and when the signaling process is concluded, that is to say the full message arrives at the end of the path, the second unit then becomes the receiver. At this point the TDM channel is up and running. Each of the two units and the HE may abort the TDM channel. For example, the HE may send an abort demand to the two units, and each of the units may themselves initiate an abort signaling process and send a notification to the HE.

In the case where the cone channel method is used, as per FIG. 3 above, each side may start signaling independently. In the case where an equal side channel is used as per FIG. 4 above, the signaling may start from the second side unit in both directions, for example, as in the case of a TDM channel from the HE. The unit may use the time slices already allocated by the HE. For example, in the case where the HE has allocated three time slices, these same three time slices may be used in the round-robin as was started by the HE.

According to an alternative embodiment, TDM channel signaling may be used to establish the TDM channel(s). The signaling messages may contain, for example, the bandwidth needed per time slot, the time sampling cycle interval, and/or the time required to place the time slot on the previous hop. In the case of equal side channels, the signaling message may contain the time slices allocated by the HE, the source, the destination, the TDM channel ID given by the HE, and/or the channel direction (e.g., whether the data is being transmitted or received). In the case where the signaling is both for up-link and the down-link, the information may be doubled, one for the transmitting direction and one for the receiving direction.

On receiving the signaling message, the transmit side unit of a hop in the TDM channel may calculate the required time slot based on the link's channel quality (CQ) and bandwidth rate available on the particular hop. In the case of a cone channel, the transmit side unit of the TDM channel may leave some room for further expansion. The transmitter side may subsequently send a message to the receiver side using the CSMA, which the receive side may acknowledge. In case of conflict, the receive side may send a negative response and may also send a map of the time slots, so that the transmitter may, for example, make adjustments and find a free time slot.

In some embodiments, where the upstream and the downstream follow a specific link, the second time slot may be used to acknowledge the previous time slot which was in the reverse direction. In this case the acknowledge message may be inserted into the message, yielding what may be referred to as a “piggyback”. The piggyback may eliminate the need to send a separate acknowledgment message, and may thereby improve the usage of bandwidth. In order to have piggyback, the TDM channel messages may be enabled to have the piggyback as an option.

In some embodiments, when establishing a TDM channel, the units which participate may aggregate the TDM channels. This aggregation may depend, for example, on having the same period for the new TDM channel or having a simple multiple period.

When using a cone channel on a given link and it is now desired to insert a new channel thereon, the signaling may require that the new channel simply be inserted in time slots on the already existing cone channel. For example, existing time slots may be extended to include the additional channel data. In other examples, the existing time slots may be destroyed and rebuilt to include the additional channel data in addition to the existing channel data.

In some embodiments, where the equal side channel is used, the signaling may include only the new TDM channel and not refer to the presence of the existing channel. The new channel may then be added to time slots of the existent TDM channels. When splitting from the previous TDM channel, the time slot for the new TDM channel may be allocated next to the time slot allocated for the existing TDM channel, in a similar fashion as in the cone channel method. In this way, a cone channel configuration may be partially or fully integrated within an equal side channel configuration.

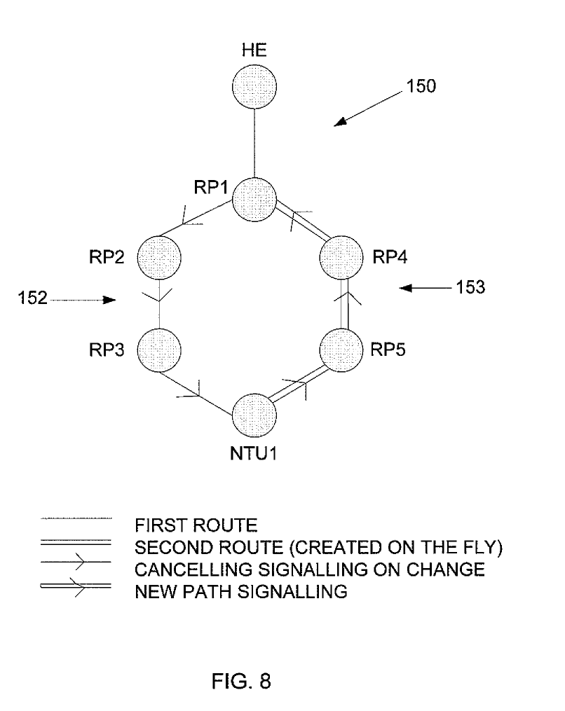

The underlying CSMA network may change dynamically. In such circumstances the best path for any given TDM channel may be changed with it in real time, that is as it were on the fly, according to some embodiments. As can be seen with reference to FIG. 8, in order to support and provide the user with a high level of service, any transmitting unit in the TDM channel may, upon every change of the best route, start signaling from its location until reaching a unit already in the TDM channel, or one of the TDM channel's end points. At this point the particular unit may initiate an abort signaling process along the old path until reaching the unit that started the channel change. The channel changing signaling may include, in addition to typical signaling information, the unit in which the channel change began. In this way the canceling signaling may know where to end. For example, in network 150, path 152 may be initiated first, between HE and NTU1. Subsequently the router may determine a preferable path 153, which may be established between HE and NTU1. In this case, the TDM channel will be switched on the fly to the new path by initiating new path signaling, for example, from NTU1 to RP1 along path 153. When the signaling process reaches RP1 it may initiate abort signaling on path 152 from RP1 to NTU1 to allow usage of the time slots that were previously being used by the previous path.

In situations where the setting up of a TDM channel causes delays, this may result in having to buffer large quantities of data at a given location. In order to reduce any backlog that may exist in bringing up a TDM channel, a channel may be established using time slots which are initially larger than the signaling calculation provided as described above. After the TDM channel reaches a steady state, the time slots may be shrunk back to their calculated levels. The initial size of the time slots established may, for example, be up to twice as large as the signaling calculation, or larger if required. This process may be referred to as “sliding time slots”. The use of sliding time slots may be avoided in the case of channel changing, since the old path may be used until the new one is established. In the case of channel aggregation, the new channel may have sliding time slots as well.

In case the canceling signaling process is lost, for example, due to link failure or channel aging, each of the links may retain the last transmission on each TDM channel. In case the channel was inactive for more then a certain time period, the unit may cancel the channel without using the canceling signaling mechanism. However, in other cases, for example when using silent suppression, where the channel may appear inactive but actually is not, the TDM channel may be assigned with a longer aging time, or the aging mechanism may be partially or fully disabled.

According to some embodiments, TMDA may be used to determine a communication path or route depending on selected criterion, for example, not necessarily taking the shortest route. In one example, in order to avoid or minimize overlapping between time slots, the TDM may use a mechanism to minimize transmission power. This may reduce the probability of overlapping time slots of unconnected hops (e.g., hops that have at least one hop in between). Minimizing the power level reduces the number of stations that hear the transmissions from a transmitting hop and therefore minimizes overlap. According to another example, According to some embodiments, when choosing the TDM channel path, the router may try to minimize the number of hops, even at the expense of bandwidth, by raising the transmission power, so that a more distant destination hop can be used. For example, for VoIP applications the TDM channel may require relatively little bandwidth and low latency. In such a case, transmission power may be increased, thereby minimizing the number of hops, and reducing the latency. The above action may reduce the number of time slots in the CSMA channel.

According to some embodiments, any unit on the network that hears another unit either transmitting or receiving in a TDM channel (may denote the TDM time slots as guard slots, that is slots that they know not to transmit in. Guard slots, as referred to hereinafter, may be defined as a time slot which a first unit in the network knows that a second unit is using to transmit or receive data in a TDM channel. The first unit thus remains inactive during the guard slot in order not to interfere with the transmission or receiving of the second unit. For example, the unit may be on the TDM channel by itself but not be a participant of this time slot. The unit in the guard state, referred to herein as “guard units”, may not transmit and may not participate in any unicast transmission. However, such a unit may receive a near-cast message from other units, although it may be required not to send acknowledgments.

Near cast transmissions, as referred to hereinafter, may be defined as messages sent by a unit to its neighbor units, using standard CSMA. These messages may be configured to be transmitted to neighboring units, yet may not be forwarded to neighboring units. For example, in FIG. 6, RP2 may send a TDM near cast message simultaneously to units HE, RP1 and RP3, including the information about all the time slots for which the unit is transmitting or receiving data in any existing TDM channel, and for which it is on guard because of any existing TDM channel.

Immediately after establishing the TDM channel, on a periodic basis, each of the units on the TDM channel and the TDM guard units may transmit a TDM near-cast message using CSMA. In the message, the unit may notify all of its near units about the time slots used to transmit, to receive and keep on guard. Each time slot may be marked with the appropriate time period.

In case a unit stops transmitting or receiving at a given time slot, it or its neighbors may mark the time slot as a free slot to avoid phony conflicts, for a selected time period.

Near-cast messages may be unreliable messages. Because they are transmitted in a broadcast fashion their reception is not guaranteed (i.e. there may be no acknowledgement messages). Because of the above, it may assumed that near-cast messages will be lost. A loss of a near-cast message can, for example, cause, a unit to receive two near-cast messages from two “nears” (neighboring units) with contradictory information. In such a case, the unit may presume that one of the two nears is not updated due to a near-cast lost. In this situation the unit may not know which of the units is more updated. However if the second unit had marked the same time slot (e.g., with the right TDM channel ID) as free, the receiving unit may figure out which one is more updated regarding the given time slot.

Accordingly, each of the time slots may be marked with the transmitter's address and the receiver's address of the specific hop, as well as the TDM channel ID and the freed slots. In the case of a guard due to another network, the time slot may be marked as an outside resource. The TDM near-cast message may be used to synchronize the TDM activities and help prevent conflicts. For example, as can be seen in FIG. 7, RP3 may have a time slot from RP3 to NTU1. However after an alternative TDM channel path has been established, RP3 will no longer be part of the TDM channel path, but will continue transmitting information via near-cast messages, where the message will include information about the time slot previously used for the TDM channel. In this way RP3 will be able to alert neighboring units that the previously used time slot is now available for usage.

A TDM channel conflict is a state in which a receiving unit can hear a time slot of another hop overlapping its receiving time slot. In this case an urgent message using the CSMA may be sent to both transmitters of those time slots. This message may cause the two or more competing transmitters to challenge each other using the CSMA messages, and subsequently to allocate new time slots where available.

In the case that a unit hears a TDM on another network for example on a neighboring TDMA network, the unit may provide an external network TDM guard by marking all the stay out time slots needed to prevent interfering with that other network. The unit may use near-cast messages to notify the outside network about these time slots, and denote these time slots with the periods and with the addresses of the participating units from that network. This kind of synchronization may require the network unit to be able to communicate with the other network.

In order to have an efficient and minimal TDM channel bandwidth allocated, all the TDM channels may use the same TDM channel period. However, according to some embodiments, it may be applicable to have a multiple of the various periods, which may be used as a base period to cover all these periods. For example: the periods 20 milliseconds, 30 milliseconds and 40 milliseconds may be enclosed by using a period of 60 milliseconds. In this way, for example, by using the 60 millisecond period for all of the TDM channels, any VoIP session that uses any of 20 milliseconds, 30 milliseconds, 40 milliseconds and 60 milliseconds time sampling periods may be supported.

According to some embodiments, in order to maintain a TDM channel the CSMA may enable time synchronization by synchronizing the units' clocks so that they may pass time slot information correctly. Accordingly, the clock may run at the same time unit, for example, a microsecond. The time unit may be metric (standard), in proportion to the basic low time scale of the CSMA network physical layer protocols, and be capable of counting the call periods.

In one embodiment synchronization may be achieved by having a single source clock or main clock for the entire network. The single source clock may be coupled to the HE or may be an external clock device associated with the HE.

In one embodiment synchronization may be achieved by having each unit in the network maintain its own clock. Using near-cast or signaling messages, any unit may transmit its clock or time value. Any unit, upon receiving the transmission, may maintain a table of clocks of each of its near units. For example, whenever a TDM near-cast or signaling transmission arrives, the unit may look in its near unit clocks table and use that unit clock to convert the time slots to match time slots according to its own clock. The time slots defined according to the unit's own clock may be used by the unit, for example, to govern transmission, receiving and being on guard.

According to some embodiments, in the case of TDM time slots from an external network, these may be managed as in the case of the “own clock”. For example, even if the network has a main clock, the own clock method may be used since there is no guarantee that the neighborhood network is using the clock from the same source, or that there is a time shift or difference between the clocks.

According to some embodiments, a method for initiating a TDM channel may include elements of a cone channel and elements of an equal side channel.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A network communication unit supporting carrier sense multiple access (CSMA) to a plurality of transmitter and receiver units on a network, the apparatus comprising:
A CSMA management module configured to support communication using CSMA with surrounding units; and
a channel management module associated with said CSMA management module and enabled to establish a multiplexed channel with at least one other communication unit over a CSMA based network.

2. The network communication unit of claim 1, wherein said CSMA based-network is a power line network.

3. The network communication unit of claim 1, wherein said multiplex channel is a time division multiplex channel.

4. The network communication unit of claim 1, wherein said channel management unit is configured to manage separate transmit and receive channels.

5. The network communication unit of claim 1, wherein said channel management unit is configured to manage separate channels when the network communications unit communicates with other units.

6. The network communication unit of claim 4, wherein said channel management unit is configured to manage separate transmit and receive channels when the network communications unit communicates with other units.

7. The network communication unit of claim 4, wherein said channels are time multiplexed channels having time slots, one of said channels is a predecessor in a multi-channel link, and another of said channels is a successor channel thereto, said channel management unit being configured to allocate said successor channel a time slot that immediately follows a time slot of said predecessor channel, thereby to minimize channel latency.

8. A carrier sense multiple access (CSMA) network comprising communication units configured to communicate with other units over said network using CSMA, at least some of the units further comprising channel support capability to set up channel connections for communicating between each other using a multiplex channel.

9. The carrier sense multiple access network of claim 8, wherein said channel support capability is located in a head end unit, such that said head end unit is configured to select units, to set up said channel connections between said selected units.

10. The network of claim 8, wherein said channel support capability comprises time division multiplexing to support time division multiplex channels.

11. The network of claim 8, wherein said channel support capability comprises time slot allocation to allow multiple channels to coexist on a given link of said network.

12. The network of claim 11, wherein said channel support capability comprises variable time slot allocation to vary bandwidth according to channel requirements.

13. The network of claim 11, wherein said variable time slot allocation is configurable to vary a width of a timeslot over a lifetime of a channel.

14. The network of claim 11 wherein said channel support capability is configured to set up successive channels along a communication path and to coordinate time slots along said successive channels, thereby to minimize latency.

15. The network of claim 11, wherein said channel support capability is configured to set up channels in multiple directions along a communication path.

16. The network of claim 11, wherein said channel support capability is configured to set up two communication paths for bi-directional communications between two given units, each path for one direction of said bi-directional communication.

17. The network of claim 11, configured to use channel sense multiple access to alert said channel support capability to set up a multiplex channel, and further configured to use time division multiplex signaling to set up said channels between units.

18. The network of claim 8, wherein said units are further configured to set time slots of paired up and down channels such that time slots in one of said channels are phased, and time slots originating at given units in the other of said channels are allocated to immediately follow a phased time slot arriving at a respective node.

19. The network of claim 8, wherein said channel management is configured to use channel sense multiple access nearcast to communicate with neighboring units regarding said multiplex channels.

20. The network of claim 19, configured such that neighboring units are informed of a multiplex channel in the vicinity using said nearcast, thereby to set up time slots of said multiplex channel as guard slots during which said respective neighboring units do not issue communications.

21. The network of claim 8, wherein said multiplex channel comprises a time division multiplex (TDM) channel.

22. The network communication unit of claim 8, wherein said CSMA network is a power line network.

23. A method of communicating over a carrier sense multiple access (CSMA) network, comprising:
using CSMA messaging to request a path over said CSMA network;
setting up multiplex channels along said path; and
communicating using said multiplex channels.

24. The method of communicating of claim 23, wherein said CSMA network is a power line network.
